(19) United States
(12) Patent Application Publication
(10) Pub. No.: US 2025/0028774 A1
(43) Pub. Date: Jan. 23, 2025

(54) DYNAMICALLY GENERATED COMPARISON USER INTERFACE

(71) Applicant: GOOGLE LLC, Mountain View, CA (US)

(72) Inventors: Nasim Sedaghat, Montreal (CA); Esteban García Sánchez, Ille de France (FR); Jorge Zuniga, Falls Church, VA (US); Katharine Giari, Mount Kisco, NY (US); Nicolas MacBeth, Beaconsfield (CA); Sébastien Séguin-Gagnon, Montreal (CA); Samuel Birch, Seattle, WA (US); Ayman Almadhoun, Seattle, WA (US); Armina Foroughi-Shafiei, North Vancouver (CA); Rui Feng, Sunnyvale, CA (US); Sara Hee Shin Park, Los Angeles, CA (US); Yue Zhang, San Jose, CA (US); Matthew Jones, Lemont, IL (US); Yu Liang Fang, Mountain View, CA (US)

(21) Appl. No.: 18/778,014

(22) Filed: Jul. 19, 2024

Related U.S. Application Data
(60) Provisional application No. 63/625,209, filed on Jan. 25, 2024.

(30) Foreign Application Priority Data
Jul. 20, 2023 (FR) 2307780

(51) Int. Cl. G06F 16/957; G06F 3/0483; G06F 16/955

(52) U.S. Cl. CPC G06F 16/9577; G06F 3/0483; G06F 16/9562

(57) ABSTRACT

A method may determine that first content in a first tab of a browser is associated with a first entity of an entity type and determine that second content in a second tab of the browser is associated with a second entity of the entity type. Responsive to determining that the first tab is associated with the first entity of the entity type and that the second tab is associated with the second entity of the entity type, a method may generate information used to provide a user interface for displaying first information for the first entity and second information for the second entity.

### CROSS-REFERENCE TO RELATED APPLICATIONS

This application claims priority to French Patent Application No. 2307780 filed Jul. 20, 2023, and U.S. Provisional Patent Application No. 63/525,909, filed on Jan. 25, 2024, the disclosures of which are incorporated by reference herein in their entirety.

### BACKGROUND

A computer user may conduct research on a topic of interest by navigating to two or more related websites via multiple tabs or browser pages in a web browser application. Users may then toggle between the websites to compare information. For example, a user planning a vacation to Europe may open browser tabs displaying content for respective websites describing travel to different European cities. The user may then switch between the tabs to compare attributes of the cities, such as transportation options, activities, and weather, between the cities.

### SUMMARY

The present disclosure relates to proactively providing a comparison user interface for entities of the same entity type. In particular, the present disclosure describes methods to determine that a user may be doing a comparison search and to surface a selectable control that can be used to generate the comparison user interface. For example, it may be determined that a user has two tabs open related to two entities of the same entity type and, based on the determination, the selectable control may be displayed. In response to selection of the control, information used to provide a comparison user interface may be generated and the comparison user interface may be displayed including at least two entities having the same entity type, each with respective entity information.

In some aspects, the techniques described herein relate to a method including: determining that first content in a first tab of a browser is associated with a first entity of an entity type and determining that second content in a second tab of the browser is associated with a second entity of the entity type; and responsive to determining that the first tab is associated with the first entity of the entity type and that the second tab is associated with the second entity of the entity type, generating information used to provide a user interface for displaying first information for the first entity and second information for the second entity.

In some aspects, the techniques described herein relate to a system including: a processor; and a memory configured with instructions to: determine that first content in a first tab of a browser is associated with a first entity of an entity type and determining that second content in a second tab of the browser is associated with a second entity of the entity type; and generate information used to provide a user interface for displaying first information for the first entity and second information for the second entity responsive to determining that the first tab is associated with the first entity of the entity type and that the second tab is associated with the second entity of the entity type.

In some aspects, the techniques described herein relate to a non-transitory computer-readable medium storing executable instructions that, when executed by a processor, cause a computing device to: determine that first content in a first tab of a browser is associated with a first entity of an entity type and determining that second content in a second tab of the browser is associated with a second entity of the entity type; and generate information used to provide a user interface for displaying first information for the first entity and second information for the second entity responsive to determining that the first tab is associated with the first entity of the entity type and that the second tab is associated with the second entity of the entity type.

### BRIEF DESCRIPTION OF THE DRA WINGS

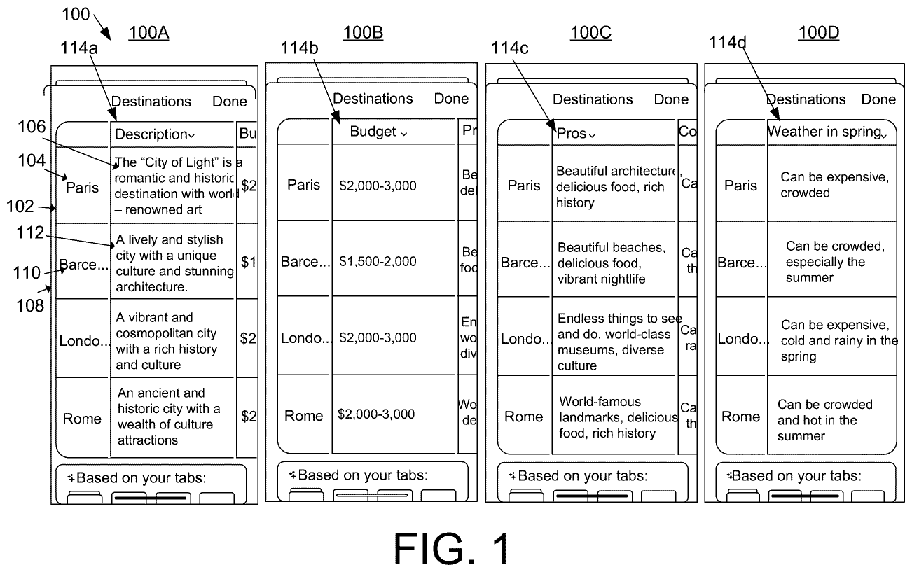

FIG. 1 depicts example comparison user interfaces, according to examples.

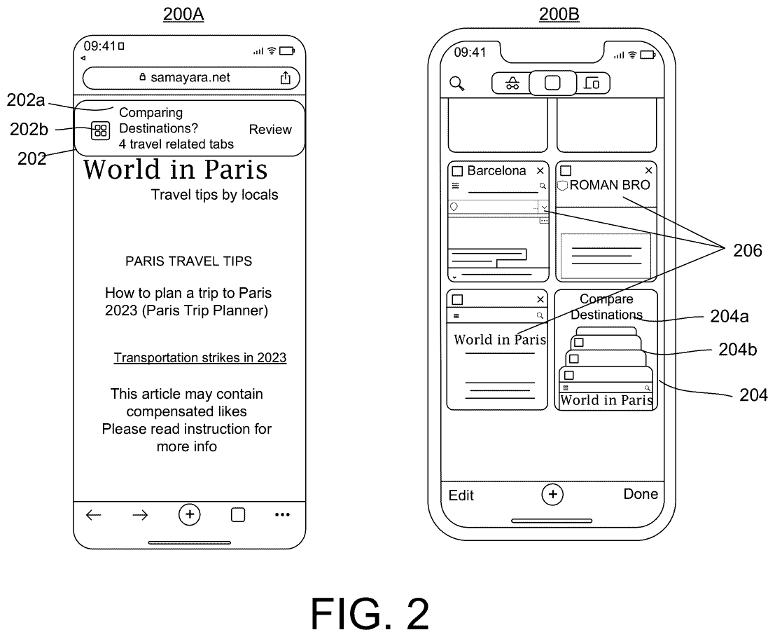

FIG. 2 depicts selectable controls for surfacing a comparison user interface, according to examples.

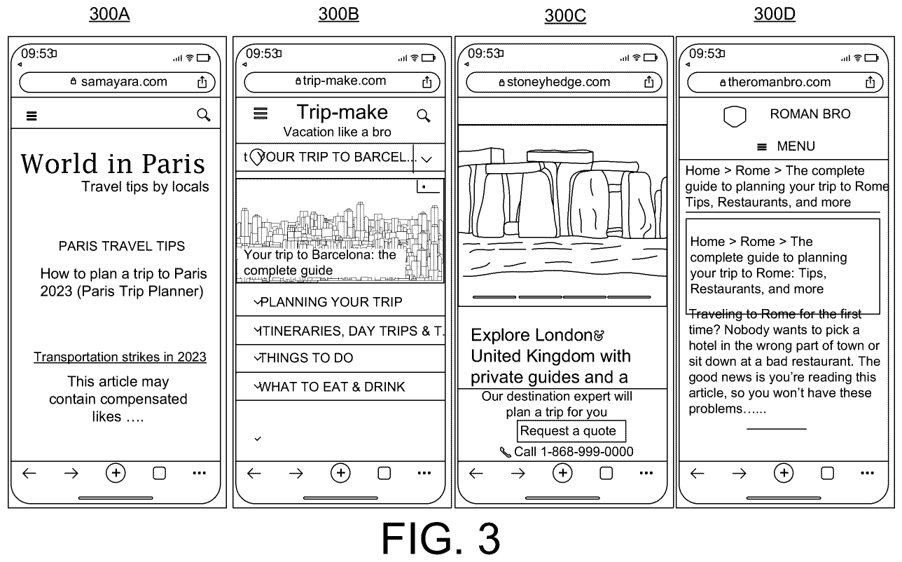

FIG. 3 depicts example browser tabs, according to examples.

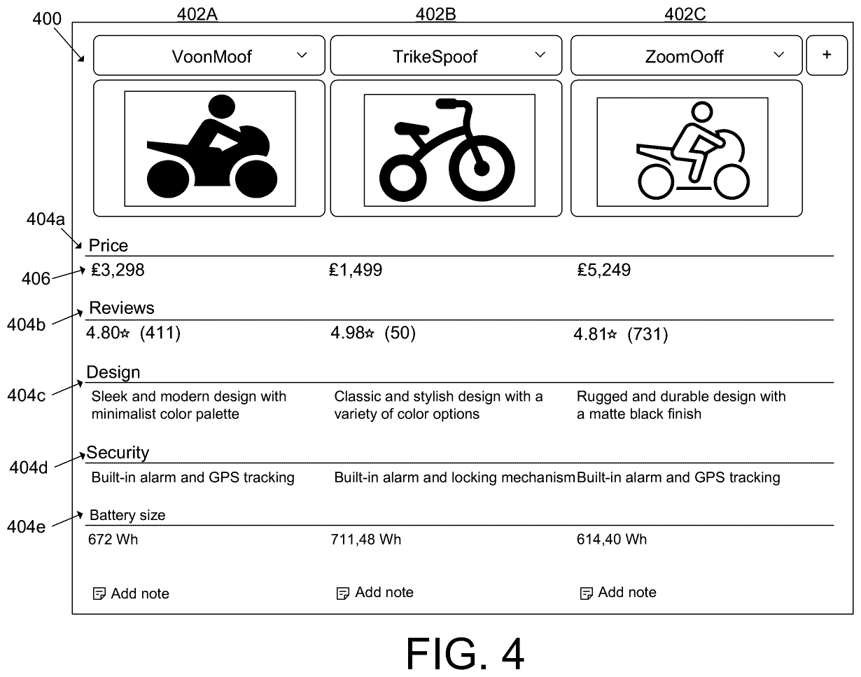

FIG. 4 depicts a comparison user interface, according to examples.

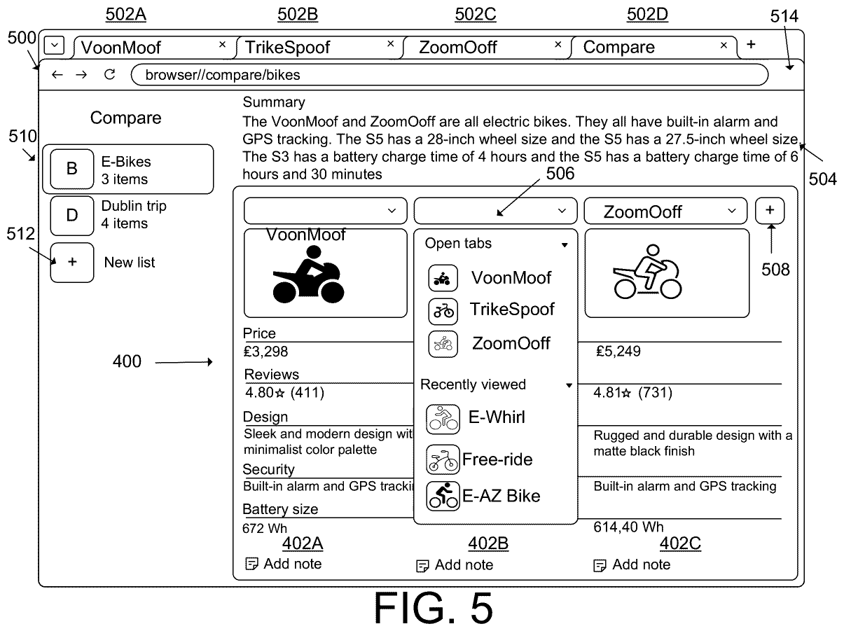

FIG. 5 depicts a comparison user interface in a browser application, according to examples.

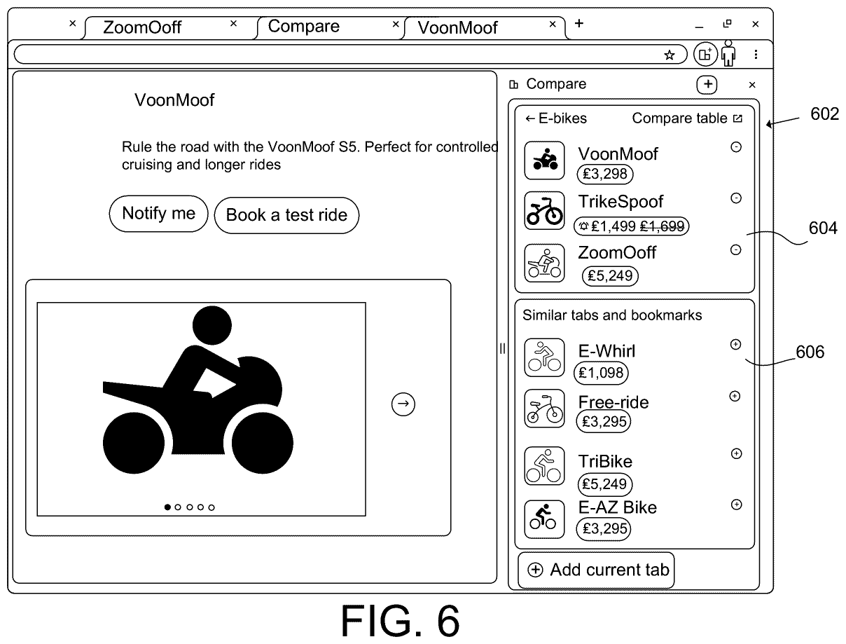

FIG. 6 depicts a comparison user interface in a browser application, according to examples.

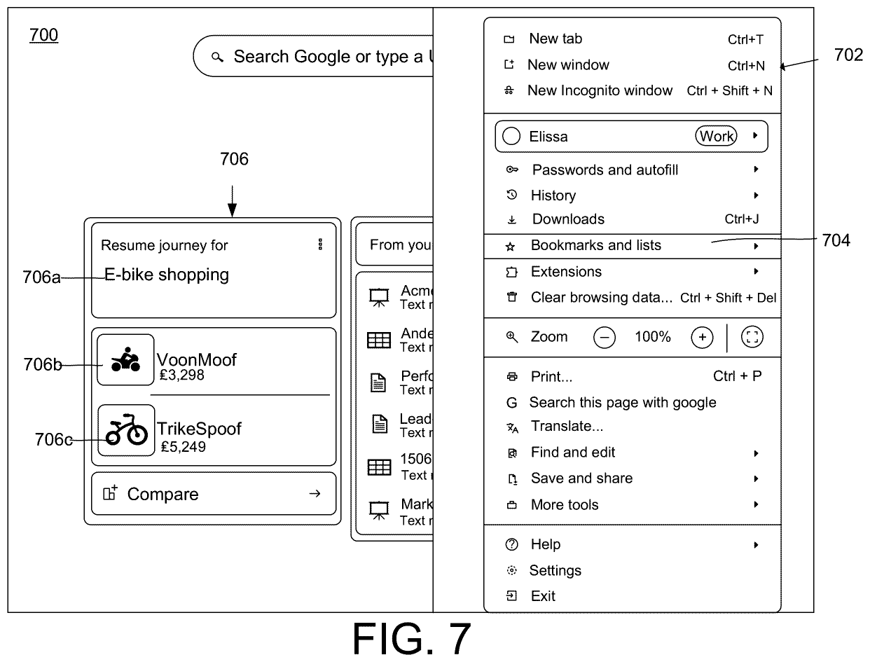

FIG. 7 depicts example options for creating or modifying a comparison group, according to examples.

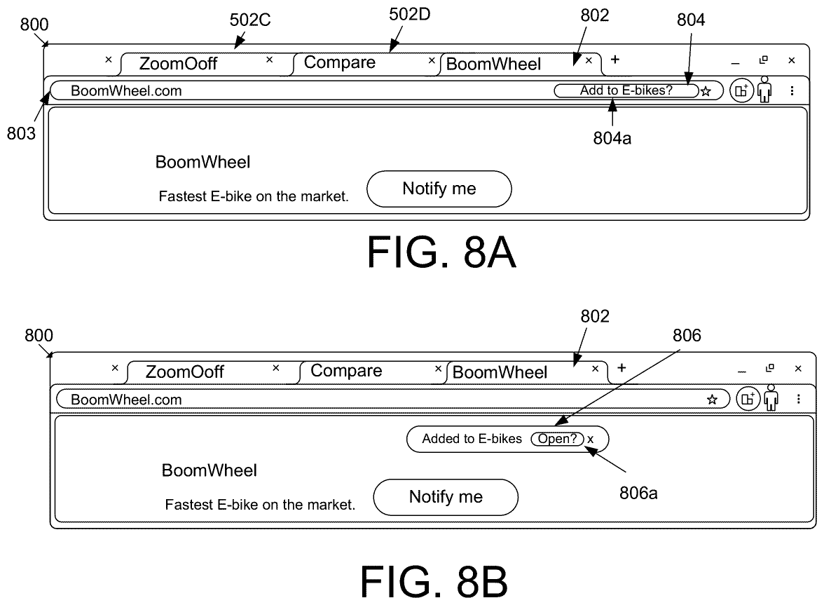

FIG. 8A depicts example options for adding an entity to a comparison group, according to examples.

FIG. 8B depicts example options for adding an entity to a comparison group, according to examples.

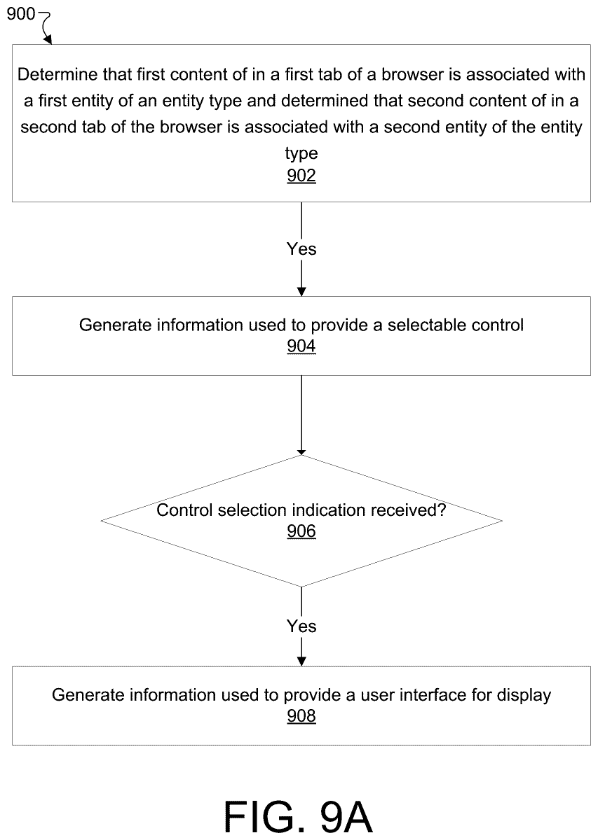

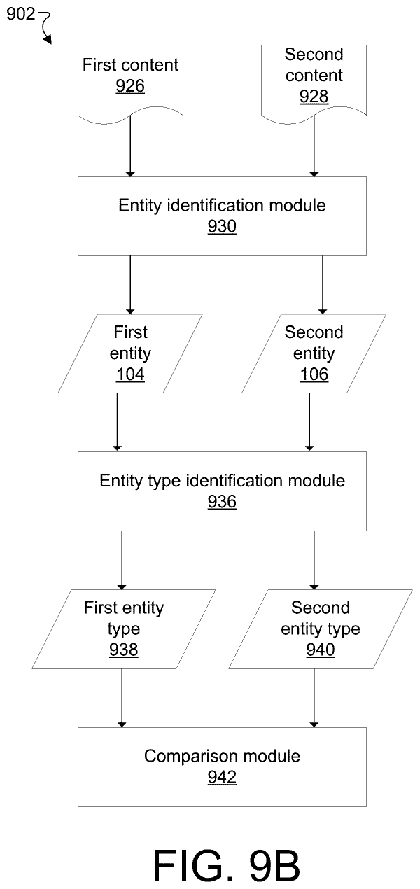

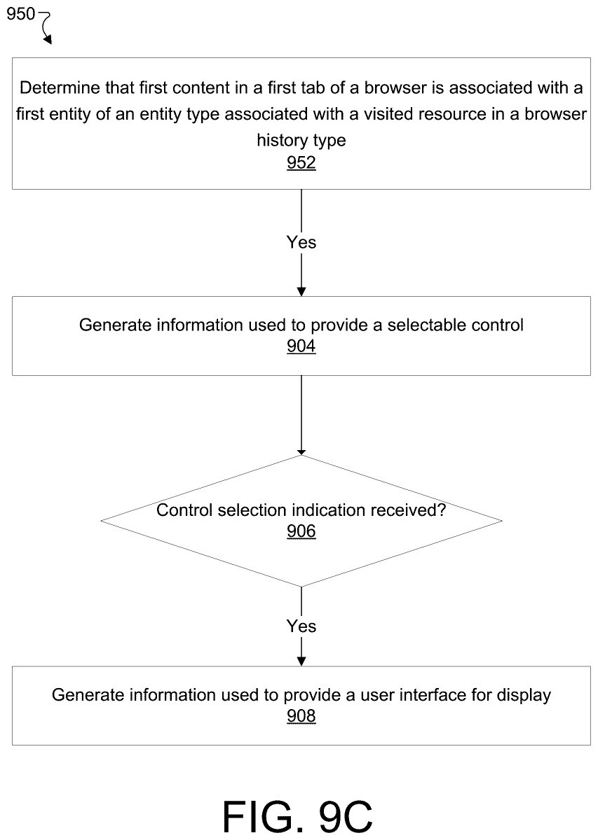

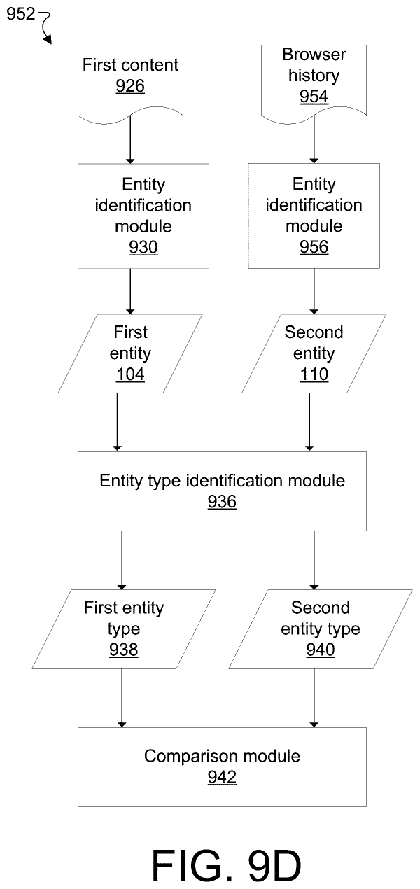

FIG. 9A depicts a flowchart of an example method that performs at least some of the concepts described herein, according to examples.

FIG. 9B depicts a flowchart of an example method that performs at least some of the concepts described herein, according to examples.

FIG. 9C depicts a flowchart of an example method that performs at least some of the concepts described herein, according to examples.

FIG. 9D depicts a flowchart of an example method that performs at least some of the concepts described herein, according to examples.

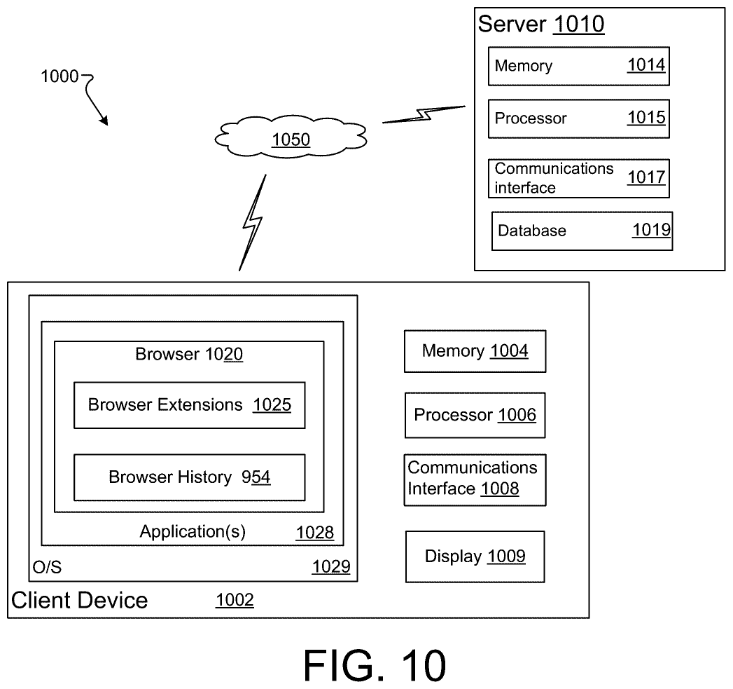

FIG. 10. depicts an example system diagram that may be used to perform the methods described herein, according to examples.

### DETAILED DESCRIPTION

This disclosure provides a way to programmatically detect that a user is performing comparative research or may like to perform comparative research and to dynamically generate a comparison user interface with relevant information related to the comparative research for the user. The disclosure further describes ways to generate, save, edit, and access comparative searches.

The process of scanning between multiple webpages to compare information across multiple entities of the same type, such as the four cities, may cause friction and be inefficient because the user needs to jump between different interfaces representing the different websites with different layouts and information, however. Due to the different layouts and content presentation, it can be difficult to put together a comparative view about any particular attribute, for example the average costs of a meal in each city. A single webpage a user consults for travel information to a city may not include all the information that a user wants to compare to the other cities. In that case, a user may need to perform a search query to find a piece of information on an additional website.

One of the technical problems addressed by the disclosure is how a user or a group of users can jump back into a past research task without encountering friction in the process. One of the technical solutions provided in the disclosure is to detect that a user is performing a research task based on at least two URLs that a user has opened in a browser application, for example via one or more tabs. Another of the technical solutions provided is to detect that a user is performing a research task based on one URL opened in a browser application and a visited resource in a browser history. As a result of the detection, implementations may provide, i.e., surface, controls to initiate the generation of the dynamically generated information used to provide a comparison interface, and/or the comparison interface itself. Another technical solution provides data structures for capturing data used to dynamically generate information used to provide a comparison interface, referred to herein as a comparison group, so that a user can save and come back to the comparison group. Such structures may enable a user to customize the interface in some implementations. Implementations may also provide entry points for resuming a saved comparison group.

Methods described herein determine that a user is conducting comparative research and/or provide a control for generating a comparative user interface with relevant information for the user. The comparative user interface improves human-computer interactions by relieving a user from having to toggle between and scan information from multiple websites to identify and compare information across different types of entities, for example cities, or for any other comparative research topic. By reducing the need for the user to switch back and forth between multiple websites, the comparative user interface may reduce the computational cycles, power consumption, and network use (bandwidth) needed to perform a research exercise. Thereby, a technical effect of increased computational efficiency and efficient use of computational resources may be achieved using disclosed implementations. Put another way, implementations assist the user in their search for data by a continued and/or guided human-machine interaction process.

While a travel journey and a shopping journey are used to describe example comparative research activities, the disclosed methods are not limited to a particular type of vertical and can be used to generate a comparative user interface for any type of entities.

FIG. 1 depicts an example comparison user interface 100. In the example of FIG. 1, the comparison user interface is depicted as a series of portions 100A, 100B, 100C, and 100D of the comparison user interface. Each of portions 100A, 100B, 100C, and 100D depict a different combination of columns from the comparison user interface 100 that can be scrolled through horizontally by the user on a display with limited display area, such as a smartphone interface.

The comparison user interface collates information relating to a first entity associated with a first website and to a second entity associated with a second website a user has visited in a browser application, such as browser 1020. In examples, comparison user interface 100 may be in the format of a table. In examples, comparison user interface 100 may include a first table element 102 including the first entity 104 and a first entity information 106 and a second table element 108 including the second entity 110 and a second entity information 112.

In examples, the first table element 102 and the second table element 108 may be columns or rows in the table. In examples, the first entity information 106 may be a fact associated with the first entity 104 and the second entity information 112 may be a fact associated with the second entity 110.

The first entity information 106 may include facts, also referred to as attributes, associated with the first entity 104 and second entity information 112 may include facts, i.e., attributes, associated with the second entity 110. The entity information may include properties about the entities or may reflect the relationship of an entity to another entity or concept. In some examples, entity information associated with an entity may be part of an entity class or ontology.

In the example of FIG. 1, the comparison user interface is depicted in several portions spread out over four screen views because it is being displayed on a display with limited display area, such as a smartphone. In the example of FIG. 1, the entities are displayed in a stationary first column and the remaining columns are scrollable so that the user can find desired entity information from a list of entity attributes. By providing the comparison user interface with a scrollable configuration, more information can be provided via the comparison interface than would otherwise be possible on a display with a limited display area. This manner of presentation provided by the comparison user interface 100 assists the user in performing a technical task by means of a continued and/or guided human-machine interaction process while making efficient use of computational resources. The scrollable configuration also reduces the processing load of the computer as the user's next interaction (i.e. scrolling) is more predictable and can be easily recognized by the user interface.

In other examples, however, the comparison user interface may be displayed on a display (such as a monitor or tablet screen) with more display area. Therefore, the comparison user interface may be displayed as a table with more columns or rows on screen, with or without the scrollable table elements.

Without the disclosed implementations, the user was required to navigate between two browser tabs or browser windows to identify information about an attribute common to the two websites. The disclosed comparison user interface 100, however, makes all the information readily available via in a single view. Collating all the information in one comparison user interface, reduces the need for the user to switch back and forth between multiple browser windows/tabs. Therefore, comparison user interface 100 may reduce the computational cycles, power consumption, and network use (bandwidth) needed to perform a research exercise, by reducing the need for retrieving and refreshing multiple tabs or windows during the research exercise.

FIG. 2 illustrates examples of selectable controls that may be provided in disclosed implementations to allow the user to initiate the generation of comparison user interface 100. For example, user interface 200A displays a selectable control 202. The selectable control 202 is a user interface element, for example a button (e.g., a call-to-action button) or image, that may be displayed over any portion of a website by a browser application, such as browser 1020. In the example, selectable control 202 displays a text field 202a that may introduce the action that will be initiated and/or the reason why selectable control 202 has been displayed. For example, the text introducing the action may be presented in the form of a question and/or a prompt. In the example of FIG. 2, the text introducing the action may be “Comparing Destinations?” letting the user know that there is an automated option to generate a comparison of travel destinations. An automated option generates the comparison user interface without user interaction. Put another way, selection of the control 202 can generate the comparison user interface without further input from the user, including selection of the entities and/or the entity attributes, although in some examples the user may be given the opportunity to edit/confirm these selections. In examples, text field 202a may provide further context for why it has been displayed. E.g., the text “4 travel related tabs” is an example of further context, which lets the user know that 4 tabs have been identified as displaying URLs relating to entities relating to a travel destination. Text field 202a may further describe the action to take place upon selecting selectable control 202 or the text field 202a itself, e.g., “review.” Selectable control 202 may further include an indication 202b to represent what may have prompted the display of selectable control 202 to the user. In examples, 202b may be an icon, symbol or image. For example, indication 202b depicts four squares inside of a square border, which may signal that multiple tabs have been found to be related to a single topic.

In examples, selectable control 202 may be displayed in response to determining that a user is performing a comparison search. For example, selectable control 202 may be displayed upon determining with user permission, that a first tab of a browser displays content associated with a first entity, which has an entity type, and that a second tab of the browser also displays content associated with a second entity having the same entity type. This may indicate that the user is presently performing a comparison search. As another example, selectable control 202 may be displayed in response to determining that first content in a first tab of a browser is associated with a first entity of an entity type, and that a second entity associated with a visited resource in a browser history also has the same entity type. This may indicate that a user is continuing a comparison search initiated at a prior time. This is explained in further detail with respect to FIGS. 9A and 9B below.

In examples, user interface 200B of FIG. 2 provides a further example of a selectable control. In the example of user interface 200B, the selectable control 204 is represented as an additional tab in a thumbnail browser interface, which also displays other thumbnail views of open user tabs 206. In the tab thumbnail view, tabs 206 are minimized to thumbnails so the user can scroll through and select individual tabs. In examples, selectable control 204 may include a text field 204a that is similar to the text field 202a and includes a title and text that introduces the action, such as a question and/or prompt. For example, like in selectable control 202, selectable control 204 asks, “Comparing Destinations?” and provides context for why selectable control 204 has been displayed, “4 tabs found.” Selectable control 204 may further include indications 204b to represent what triggered the display of selectable control 204 for the user. In examples, indication 202b I may include any of the features described with respect to 202b above. In the example, indication 204b depicts indications of the content of the tabs that will be used in generating the comparison user interface, i.e., tabs determined to be related to the same entity type. In some examples, the indications of the content can include titles of the web pages. In some examples, the indications can include the resource locators (e.g., URLs), or a portion thereof, such as just the domain. In some examples, the indications can include different representations or orientations of thumbnail views of tabs (e.g., vertically or horizontally stacked thumbnail views of the tabs, overlapping or side-by-side) determined to be related to the same entity type. In examples, indication may include representations of the same number of thumbnail views of tabs as entities in the table. In examples, the indication may include other representations associated with the content within the thumbnail views of the tabs (e.g., representations of images or titles within the content).

In examples, further ways of displaying a selectable control may be provided. Although the example user interface 200A and user interface 200B are formatted for devices with limited display area, the techniques describe herein could be used on a computing device with a much less limited display, such as a desktop or laptop. In examples, a selectable control may be displayed in a menu, in a sidebar, or in a chip that can be surfaced when a comparison search is detected. A chip is a selectable control can be surfaced, i.e., displayed, in an address bar area in a browser. The address bar area can include an input address area configured to receive text from the user. The chip can include text and/or an icon. In some examples, the chip may be removed from the address area after a predetermined time if the chip is not selected by the user. In response to selection by a user, selectable control 202, 204 may be configured to initiate the generation of comparison user interface 100, or another example of the comparison user interface.

In examples, different actions may trigger the surfacing or display of selectable control 202, 204, with user permission. For example, FIG. 3 depicts a prior comparative search conducted by a user. In the example, a user has visited several different websites in different browser tabs of a single browser application, illustrated as tabs 300A, 300B, 300C, and 300D. In a further example, however, a user may open one or more respective browser pages in a browser application, such as browser 1020. Example tabs 300A, 300B, 300C, and 300D include content from URLs that relate to cities in Europe that the user is interested in traveling to. The example comparative search represented indicates that the user is interested in comparing travel destinations. In this particular example, the travel destination are four European cities: tab 300A depicts a website directed to travel to Paris, tab 300B depicts a website directed to travel to Barcelona, tab 300C depicts a website directed to travel to London, and tab 300D depicts a website directed to travel to Rome.

Performing the comparative search of FIG. 3 may require opening, closing and refreshing multiple browser tabs and/or browser windows and may also include switching between multiple browser tabs and browser windows in succession, for example, via swiping movements or touch events. The comparative search may also include generating new searches or inputting new information into a browser tab or window. Switching between tabs 300A, 300B, 300C, and 300D to identify information about a common attribute, such as typical weather conditions in each city, for example, is computationally inefficient, navigationally complex, and visually confusing.

In examples, the first website and the second websites may be currently open in a browser application. In further examples, however, any combination of the first website and the second website may have been accessed previously by a user, with this information being stored in a browser history.

In examples, comparison user interface 100 and/or selectable control 202, 204 may be displayed in response to determining that at least a first website and second website displayed on two tabs, for example tab 300A and tab 300B, are associated with respective entities relating to the same entity type. Further details for what events may initiate the display of comparison user interface 100 and/or selectable control 202, 204 are provided below with respect to FIGS. 9A and 9B.

FIG. 4 depicts an example comparison user interface 400 including table elements 402A, a 402B, and a 402C, which each relate to a different entity in a comparison search. In the example, each entity displayed in comparison user interface 400 relates to an electric bike, which may be the subject of an online transaction. First table element 402A relates to a first entity, a VoonMoof bike, second table element 402B relates to a second entity, a TrikeSpoof bike, and third table clement 402C relates to a third entity, a ZoomOoff bike. Comparison user interface 400 is arranged vertically with table elements positioned under related entities, but in examples, comparison user interface 400 may also present the table elements in a horizontal format.

Comparison user interface 400 may include one or more entity information categories (e.g., information categories) across the first, second, and third table elements 402A, 402B, and 402C. In the example, each entity information category includes information that may be particularly helpful for a user trying to do a comparison shopping search for an electronic bike (e.g., an e-bike). For example, a first entity information category 404a is directed to price, a second entity information category 404b is directed to reviews, a third entity information category 404c is directed to design, a fourth entity information category 404d is directed to security, and a fifth entity information category 404e is directed to battery size. Each respective entity information category 404a-404e for each respective table element 402A, 402B, and/or 402C may have a respective entity information data 406.

FIG. 5 depicts a comparison user interface in a browser window 500. In the example of FIG. 5, a user has browser window 500 open with a first tab 502A, a second tab 502B, and a third tab 502C. In an example, browser window 500 may determine that some combination of first tab 502A, second tab 502B, and third tab 502C relate to a comparison group or research task. Browser window 500 may have surfaced a selectable control (not pictured in FIG. 5) that was selected by the user; in response to the selection the browser may have generated information used to provide the comparison use interface and displayed the comparison user interface in a new tab, e.g., tab 502D, in response to selection of the selectable control. In examples a user selectable control can comprise a popup window, a menu option, a card on a new tab page, and/or a chip in the address bar area 514, as explained herein.

In an example, comparison interface tab 502D may illustrate one example implementation of a comparison user interface 400. Comparison interface tab 502D includes comparison user interface 400 plus a summary section 504. In examples, a summary service may generate a summary using a generative language model (e.g., a large language model). A generative language model is a type of machine-learning model that uses deep learning to generate a response based on a prompt and a context. Language models are trained on vast amounts of data, typically in the form of text or speech, and can be configured (trained) to use this data to predict entities and/or entity types associated with webpages. Using prompts and context as inputs, language models generate outputs or responses. A prompt is an input to which the language model generates a response. Prompts can include instructions, questions, or any other type of input, depending on the intended use of the model. In some implementations the summary service may provide a prompt to the language model that asks for a summary of any combination of the entity information found on web pages associated with particular tabs, i.e., the tabs determined to relate to entities of the same type. In examples, the prompt may use entity information relating to any combination of the entities associated with table elements 402A, 402B, and/or 402C. In examples, the prompt may use one or more entities associated with a comparison search to generate the summary.

In examples, browser window 500 may include one or more ways to add or change the entities associated with table elements, such as table elements 402A, 402B, or 402C. For example, FIG. 5 depicts a dropdown menu 506. Dropdown menu 506 may be accessed via an arrow positioned next to the title of table element 402B and used to select a different entity for table element 402B. For example, dropdown menu 506 may offer a way to switch the entity associated with table clement 402B. The entities in the dropdown menu 506 may be entities associated with another tab. The entities in the dropdown menu 506 may be entities associated with a recently viewed or bookmarked URL. The entities in the dropdown menu 506 may be entities associated with a browsing history located on the user device. In examples, the browser window 500 may enable the user to type in and/or search for an entity. In examples, the user may have access to controls to modify how the browser history is used to generate the entities displayed in dropdown menu 506.

In examples, browser window 500 may include an adding control 508. In FIG. 5, adding control 508 may comprise a selectable icon near, e.g., adjacent to, table elements 402C. In some implementations the selectable icon may include/depict an icon. The icon can suggest addition, such as an icon including a plus sign. Adding control 508 may be configured to, in response to selection by a user, add additional table elements associated with additional entities to comparison user interface 400.

In examples, browser window 500 may include a side panel 510. Side panel 510 may be used to create, access, or modify a comparison group or a research task. In examples, side panel 510 may include a comparison group creation control 512 which may be configured to, in response to selection by a user, create a new comparison group. Although illustrated a left side of the display, the side panel 510 may be located on a right side, on a top, or on a bottom of the display.

FIG. 6 depicts a browser window 500 with a comparison user interface configuration sidebar 602, according to examples. Comparison user interface configuration sidebar 602 may provide a way to select and/or change entities for a comparison search.

In examples, comparison user interface configuration sidebar 602 may include a current entity panel 604. Current entity panel 604 may help the user understand what entities are already included in comparison user interface 400. By interacting with current entity panel 604, a user may be able to remove or add entities to comparison user interface 400. In examples, selecting the current entity panel 604 may initiate the generation of comparison user interface 400, similar to selectable controls 202, 204.

In examples, comparison user interface configuration sidebar 602 may further include additional entities panel 606. Additional entities panel 606 may include further entities that may be added to comparison user interface 400 for comparison. In examples, the entities displayed in additional entities panel 606 may have the same entity type as one or more of those included in current entity panel 604. In examples, entities of a different types may be added to comparison user interface 400 for comparison. In examples, the entities displayed in additional entities panel 606 may be identified from open browser tabs or windows, the browser history, bookmarks file, a database, a query, or via a language model.

FIG. 7 depicts example options for creating or modifying a comparison group within a new tab page 700 within browser window 500, according to examples. In examples, a menu 702 may be used within new tab page 700 or any other tab to allow a user to create or modify a new comparison group, for example via the ‘bookmarks and lists’ option 704. In examples, option 704 may allow a user to delete a comparison group.

In examples, the new tab page 700 may include a comparison search return option 706 to, upon selection from the user, jump back into a previous comparison search. In examples, comparison search return option 706 may offer a thumbnail view of the comparison search itself and text or indications to remind the user about the content of the comparison search. For example, comparison search return option 706 may include text 706a signaling what happens upon selection, “Resume journey for” and the title of the comparison search, “E-bike shopping”. Comparison search return option 706 may further include a first representation 706b of a first entity and a second representation 706c of a second entity. First representation 706b and second representation 706c may include any combination of indicators and/or text (e.g., a name or title of an entity, or any other description of an entity) relating to an entity.

In examples, comparison search return option 706 may be displayed in other contexts or user interfaces besides new tab page 700. In an example, comparison search return option 706 may be displayed within a browser history.

Browser window 500 may allow comparison groups to be modified by allowing URLs and/or entities to be added or removed. In examples, browser window 500 may allow for comparison groups may be created or deleted. In examples, comparison groups may be automatically generated, with user consent, by providing the language model with the browser history as input.

In examples, a comparison group may be shared and/or permissions to comparison groups may be granted to other users so that multiple users may modify and/or interact with the comparison group. In examples, the comparison group may be synchronized between one or more client computing devices or on a server. In examples, the comparison group may be accessed by more than one user on separate client computing devices.

In examples, comparison groups may be saved. In examples, the user may delete comparison groups. A comparison group may include entities and related URLs. For example, in the example of shopping, the comparison group may include product identifiers and/or locators of web pages that describe the product, i.e., product URLs.

In examples, the comparison group may include a title generated using the language model. The title may be editable by the user.

In examples, a user may be able to add a third entity to a comparison group that is not the same entity type as the first entity and the second entity. In examples, the first entity and the second entity may have entity types that share a parent, a grandparent, a great grandparent, or not be closely related in an entity repository. In examples, a comparison user interface generated using that comparison group may include entity information categories that the third entity does not have information relating to. For example, if a comparison user interface is displaying information relating to electric bikes, a pedal bike may be added. Because the pedal bike has no battery, that entity information category may be left blank for the third entity. This may allow for a comparison user interface that appears consistent despite including entities with different entity types.

The methods described herein allow for the dynamic detection of a

comparison research effort and generation of helpful information relating to a comparative research effort in one display without a need to search through multiple web documents across multiple browser tabs/pages.

FIG. 9A depicts method 900 in accordance with an example and FIG. 9B provides an example implementation of step 902 via steps 926-942. Method 900 may be used to automatically detect that a user is performing research on a topic (e.g., represented by an entity type) and/or to generate a comparison user interface relating to the research. Method 900 may include any combination of steps 902-908. In examples, any combination of steps from method 900 may be executed on a browser on a client device or a server. In examples, portions of method 900 may be executed on a browser extension or plug-in.

Method 900 may begin with step 902. In step 902, it may be determined that first content in a first tab of a browser is associated with a first entity of an entity type and determined that second content in a second tab of the browser is associated with a second entity of the entity type.

In FIG. 9B, entity identification module 930 may receive first content 926 and generate first entity 104, and/or receive second content 928 and generate second entity 110. In an example, first content 926 and second content 928 may include information displayed in a browser tab or browser window of a browser application that is associated with a document, or a URL. Entity identification module 930 is operable to identify which entity is associated with each of first content 926 and second content 928. For example, the content of browser tab 300A and browser tab 300B of FIG. 3 may be determined to be related to travel to different European cities. The browser tab 300A may be an example of first content 926 and the browser tab 300B may be an example of browser content 928. In this example, entity identification module 930 may identify first entity 104 and second entity 110 from the browser tab 300A and 300B. Identifying first entity 104 and second entity 110 may include determining first metadata from the first website and second metadata from the second website. The metadata may comprise information within the document a user is accessing via a website that is not displayed as content for the user. For example, first and second metadata may comprise HTML tags and/or schema.org markup. In examples, first and/or second metadata may include at least one of a title, a description, or a URL. In examples, first and second metadata may be extracted from the HTML document itself, a document object model, an accessibility tree, or a PDF file.

In examples, the metadata or content displayed in a tab may be used to lookup an entity in a database.

In examples, determining the first and second entities may comprise using a language model. In examples, the prompt for the language model may include instructions based on metadata such as, “Based on title XX and description YY, please provide an answer that includes only the main subject entity.” In the example of conducting travel research, the prompt may comprise, “Based on the title XX and description YY, please provide an answer that includes only a main travel location or destination.”

Upon determining first entity 104 and second entity 110, an entity type identification module 936 may be executed. Entity type identification module 936 may be executed with first entity 104 and/or second entity 110 as inputs to generate first entity type 938 and second entity type 940, respectively.

In the example of FIG. 3, first entity type 938 and second entity type 940 may be a place, a European city, or travel destination, for example. In other examples, however, first entity type 938 and second entity type 940 may be a product, a person, an organization, an article, or another entity type defined in an ontology of classification system, for example.

In examples, entity type identification module 936 may determine first entity type 938 or second entity type 940 using a database, knowledge graph, or machine learning module.

In examples, first entity 104 or second entity 110 may have a known entity type from an entity repository, such as a knowledge graph or a database (e.g., a database supporting transactions that involve entities). An entity repository may include people, places, or things as defined by the entity repository. Through relationship extraction and inference engines, entities become interlinked and populated with facts in an entity repository, such as a knowledge graph. The first and second entities may be instances of an entity type.

In examples, entity type identification module 936 may use a clustering algorithm to determine that a first entity and a second entity are related and have a same entity type. The clustering algorithm may determine that there are visits (evidenced, e.g., via one or more open tabs or via the browser history) associated with first content 926 and second content 928 that may relate to entities of the same type or to common tasks. In examples, the clustering algorithm may determine that two or more tabs are related based on metadata for and/or content found in the webpages represented by the tabs. If at least two (or some other predetermined number) of tabs share a common task or entities of the same type a comparison group cluster may be created. A comparison group may store the resource addresses (e.g., the URLs) of the webpages. The comparison group may identify a comparison group topic. The comparison group may identify webpages from a browser history related to the comparison group topic.

Once first entity type 938 and second entity type 940 are determined, they may be compared via comparison module 942. In examples, comparison module 942 may determine if first entity type 938 and second entity type 940 are the same or closely associated, thereby indicating that a user may be performing, or may be interested in performing a comparison search relating to first content 926 and second content 928.

In examples, comparison module 942 may determine that first entity type 938 and second entity type 940 are related if they are the same entity type. In examples, comparison module 942 may determine that first entity type 938 and second entity type 940 are related if they are adjacent to one another in an entity repository including a hierarchy of entity types. In examples, comparison module 942 may determine that first entity type 938 and second entity type 940 are related if they are within a predetermined number of generations or connections to one another in an entity repository.

In examples, method 900 may continue with step 904. In step 904, a selectable control may be provided. For example, selectable control 202, selectable control 204, or current entity panel 604 may be displayed.

In examples, method 900 may continue with step 906. In step 906, a control selection indication may be received if a user selects selectable control 202.

In examples, method 900 may continue with step 908. In step 908, information used to provide a user interface may be generated, such as: an entity type, one or more entities, one or more entity information categories, one or more elements of entity information, a title, a summary, a comparison group, etc. For example, information used to provide (generate) comparison user interface 100 or comparison user interface 400 may be generated and the user interface generated and displayed. Thus, in examples, step 908 may further include displaying the comparison user interface. The comparison user interface may collate information relating to the first entity of the first entity type 938 and the second entity type 940 that are the same entity type. Whereas previously, the user was required to navigate between the first website and the second website using multiple browser tabs or multiple browser windows (e.g. scrolling between portions 100A, 100B, 100C, and 100D of the comparison user interface 100 to identify information about a common attribute), now all the information may be readily available via the comparison user interface. Collating all the information for display in one comparison user interface, reduces the need for the user to switch back and forth between multiple browser windows/tabs. Therefore, the comparative user interface may reduce the computational cycles, power consumption, and network use (bandwidth) needed to perform a research exercise, by reducing the need for retrieving and refreshing multiple tabs or windows during the research exercise.

In examples, a language model may be executed using the first metadata and the second metadata as inputs to generate the information used to provide the comparison user interface. In examples, the first entity and second entity may be used as inputs or context to the language model. In examples, the language model may be trained on web snippets including facts and/or qualitative information. An example prompt for the language model to generate the information used to provide the comparison user interface may include, “You are an expert travel agent with extensive knowledge on all travel destinations worldwide. Create a table comparing the following cities: {destinations}. Include columns for description, budget, weather in spring, pros, and cons. For the budget, give an approximate USD amount for a 2-week trip.”

In examples, a clustering algorithm may use a language model to determine what websites from open tabs should be included in a comparison group for display in the comparison user interface. For example, metadata and/or content from the websites may be provided as input and the language model may provide an output that includes either entity types for the two or more tabs, an entity type for each of or any combination of the two or more tabs, or a determination of whether the two or more tabs are related.

In examples, first entity information 106 and second entity information 112 may relate to a first entity information category. An entity information category may be a type of fact available for the entity type. For example, in portion 100A, an entity information category 114a is listed at the top of the comparison user interface, “Description”. In portion 100B, the entity information category 114b is “Budget”, in portion 100C the entity information category 114c is “Pros”, and in portion 100D the entity information category 114d is “Weather in Spring”. In examples, the entity information category may be selectable, for example via a drop down menu. In examples, a user may be able to search for or request desired entity information categories, such as, for example, “Weather in Winter.”

In examples, an entity information generation service may be executed to generate entity information 106, 112. In examples, the entity generation service may access a database and use the attributes found therein to determine one or more entity information categories. For example, a database relating to shopping may have relevant entity information categories for different types of goods. In examples, the entity generation service may include using a prompt with a language model to ask for one or more entity information categories based on one or more entities, an entity type, or comparison group.

In examples, first entity information 106 may be determined without reference to displayed content of the first website and/or the second entity information 112 may be determined without reference to displayed content of the second website. For example, first entity information 106 and second entity information 112 may be determined only based on metadata, without reference to content that is displayed for a user in a website.

In examples, first entity information 106 and second entity information 112 may be determined without reference to a database.

In examples, generating the comparison user interface may further include providing a language model with first entity 104 and second entity 110 as inputs to generate first entity information 106 and second entity information 112. In examples, first entity information 106 may be determined based on first metadata associated with tab 300A and second entity information 112 may be determined based on second metadata associated with tab 300B. In examples, first entity information 106 may be determined without reference to non-metadata content in tab 300A and second entity information 112 may be determined without reference to non-metadata content in tab 300B.

In examples, first entity information 106 may include both database information and contextual information. The database information may include facts determined using a database. The contextual information may provide context for facts and be determined using a language model using the database information as input. This may allow for first entity information 106 to include quantitative information via the database information and contextual information about the quantitative information. For example, an electric bicycle may have a 2.2 Ah battery and the contextual information may say, “reviews praise all day battery”.

In examples, the comparison user interface may include one or more summaries which may be generated using a language model using first entity 104, first entity information 106, second entity 110, and/or second entity information 112 as input(s). For example, FIG. 5 displays an example summary section 504.

In examples, generating comparison user interface 100, 400 may further comprise providing a language model with first entity 104 and second entity 110 as inputs to generate a title. For example, FIG. 7 depicts a title for a comparison user interface that can be generated to resume a shopping journey, “E-bike shopping.”

In examples, it may be possible to generate an entity information category using the language model and any combination of first entity 104, second entity 110, and first entity type 938 as inputs. For example, the prompt may include, “Create a table comparing a list of cities that a user interested in {destination 1 and 2} may like/with {this browser history} may like/with {these user preferences} may like.”

In examples, it may be possible, with user consent, to personalize some of the data in the comparison user interface to the user. It may be possible to modify the prompt to compare any entity information category for any entity type and/or entity. For example, it may be determined, with user consent, from browser history or other data that the user is a foodie who likes Michelin-starred restaurants and spends significant time researching high-end dining. A prompt may be generated to skew the information presented in the comparison user interface toward high-end restaurants and take cost into consideration when putting together a cost estimate for a 2-week trip.

In examples, the user may be able to create an attribute for comparison user interface 100, 400 manually. For example, the user may be able to generate an entity information category.

The first entity information 106 and the second entity information 112 may be presented side-by-side in a condensed format. The condensed format may be a summary of further information that is also available. In this way, the comparison user interface may provide a snapshot of the information available to the user.

Comparison user interface 100, 400 may allow a further selection of, for example, first entity information 106 (e.g. relating to budget) if the user would like to find out more information about a topic. Comparison user interface 100, 400 may thus provide an efficient method for presenting initial information. Then, if the user would like more information, a selection can be made and, for example, the user can be directed to a web page. In this way, the method conveys information to the user in the form of a technical tool that enables the user to perform the technical task of interactively searching and retrieving stored information relating to a least first entity 104 and second entity 110 more efficiently.

In examples, there may be user interface elements to facilitate adding an entity to a comparison search. For example, FIGS. 8A and 8B depict a browser window 800, according to an example. Browser window 800 may display several tabs, for example third tab 502C displaying content relating to a URL associated with ZoomOoff and second tab 502B displaying a comparison user interface, such as comparison user interface 400.

Responsive to determining that browser window 800 includes a tab 802 which displays information relating to a new entity that is potentially related to but not yet part of a comparison user interface, a selectable control 804 may surface or be displayed within browser window 800, for example adjacent to address bar 803. Selectable control 804 may allow a user to add the new entity to a comparison user interface. Selectable control 804 may include a text field 804a operable to introduce the action that will be initiated upon selection of selectable control 804. In the example, text field 804a identifies that an entity relating to tab 802 may be added to the comparison group E-bikes upon selection of selectable control 804, “Add to E-bikes?”.

Responsive to selection of selectable control 804, the new entity relating to tab 802 may be added to a comparison group. As depicted in FIG. 8B, a confirmation indicator 806 may be displayed in response to selection of selectable control 804. The confirmation indicator 806 may include a text field 806a to help confirm to the user that the new entity has been added to the comparison group. The example text field 806a includes the confirmatory text, “Added to E-bikes”. In examples, confirmation indicator 806 may also include or be associated with a selectable control 806b operable to open the comparison group to which the new entity was added upon being selected. In FIG. 8B, the example selectable control 806b is in the form of an oval button including the text, “Open?”.

FIG. 9C depicts a method 950 according to an example. Method 950 may be used to automatically detect that a user is performing research on a topic (e.g., represented by an entity type) and/or to generate information used to provide a comparison user interface relating to the research. Method 950 may include any combination of steps 952 and 904-908.

Method 950 begins with step 952. In step 952, it may be determined that first content in first tab 300A of a browser is associated with first table element 102 of first entity type 938 associated with a visited resource in a browser history.

FIG. 9D provides an example implementation of step 952. As may be seen in the figure, first content 926 is received at an entity identification module 930, which generates first entity 104, as described above. Entity type identification module 936 receives the first entity 104 to generate first entity type 938, as described above with regards to FIG. 9B.

With consent from the user, in step 952 a browser history 954 may further be received by an identity identification module 956 to generate a second entity 110. Browser history 954 may include a record of the sites a user has visited in the past, including URLs, titles, dates/times visited, download history, search history, cookies, cache, and other information. In examples, identity identification module 956 may only access visited resources that a user has accessed within a predetermined horizon of time.

Identity identification module 956 may input a visited resource from browser history 954 to generate second entity 110. In examples, identity identification module 956 may include many of the same features described with regards to entity identification module 930 above. In examples, identity identification module 956 may further request information from a server regarding content and/or metadata relating to the visited resource. In examples, identity identification module 956 may evaluate at least portion of browser history 954 to identify multiple entities relating to multiple visited resources. In examples, identity identification module 956 may evaluate one or more visited resources in browser history 954 to determine if there clusters of topics are present.

In examples, identity identification module 956 may execute a language model using browser history 954 information as input. For example, the context may further include any portion of browser history 954 to generate second entity 110.

In examples, the rest of step 952 may look similar to that described for step 902 above. Entity type identification module 936 may be received each of first entity 104 and second entity 110 as inputs, generating first entity type 938 and second entity type 940, respectively. Comparison module 942 may determine whether first entity type 938 and second entity type 940 are associated, which may trigger the generation of information used to provide comparison user interface 100, 400 and/or selectable control 202, 204.

In examples, methods may independently identify one or more clusters among visited resources in browser history 954 or saved in browser history 954 itself. In examples, the cluster(s) may be associated with a topic and/or an entity type, which may be used to generate information used to provide comparison user interface 100, 400.

More than one language model may be used to perform the methods described in the present description. Each language models may be trained with different targeted sets of data to optimize the language model to generate the most accurate outputs.

FIG. 10 depicts a system 1000 that may execute the methods described herein, according to an examples. System 1000 includes a client device 1002 and a server 1010 in communication via a network or the internet 1050.

Client device 1002 includes a non-transitory memory 1004, a processor 1006, and a communications interface 1008. Client device 1002 is in communication with a display 1009, which may be internal or external.

The client device 1002 may include an operating system 1029 upon which applications 1028 may execute. Applications 1028 represent specially programmed software configured to perform different functions.

One of the applications 1028 may be the browser 1020. The browser 1020 may be configured to display webpages, execute web applications, and the like in one or more windows or tabs. The browser 1020 may include additional functionality in the form of browser extension 1025, e.g., a browser plug-in. Examples of windows and tabs from the browser 1020 are displayed in FIGS. 2, 3, and 5. The browser extension 1025 may be configured to, with user permissions, determine when the user has navigated to two or more websites that relate to different entities for the same topic (i.e., for the same entity type) and initiate a dynamic entity comparison user interface, as described herein. Browser 1020 further includes browser history 954, as described above.

The client device 1002 may communicate with the server 1010 over a network. Server 1010 includes a non-transitory memory 1014, a processor 1015, a communications interface 1017, and a database 1019. The server 1010 may store in the memory 1014 instructions that, when executed by the processor 1015 cause the server 1010 to perform operations, such as working with the client device 1002 to generate information used to provide a comparison user interface.

The server 1010 may be a computing device or computing devices that take the form of a standard server, a group of such servers, or a rack server system. In some examples, the server 1010 may be a single system sharing components such as processors and memories. The network may include the Internet and/or other types of data networks, such as a local area network (LAN), a wide area network (WAN), a cellular network, satellite network, or other types of data networks.

In examples, database 1019 may include one or more databases. In examples, database 1019 may include an entity repository including a hierarchy of entity types. In examples, database 1019 may include predetermined entity information categories for various entity types. In examples, database 1019 may include information about entities, for example details about E-bikes.

In examples, any combination of steps from method 900 may be executed on client device 1002 or server 1010.

In some aspects, the techniques described herein relate to a method, further including: providing a selectable control responsive to determining that the first tab is related to the first entity of the entity type and to the second tab related to the second entity of the entity type; receiving selection of the selectable control; and generating the information used to provide the user interface in response to receiving the selection of the selectable control.

In some aspects, the techniques described herein relate to a method, wherein generating the information used to provide the user interface further includes providing a language model with the first entity and the second entity as inputs, the language model generating an information category relating to the first information and the second information.

In some aspects, the techniques described herein relate to a method, wherein generating the information used to provide the user interface further includes determining an information category for the entity type using a database, the information category associated with the first information and the second information.

In some aspects, the techniques described herein relate to a method, wherein generating the information used to provide the user interface further includes using a language model to generate the first information and the second information given the first entity and the second entity as inputs.

In some aspects, the techniques described herein relate to a method, wherein the first information is determined based on first metadata associated with the first tab and the second information is determined based on second metadata associated with the second tab.

In some aspects, the techniques described herein relate to a method, wherein the first information is determined without reference to non-metadata content in the first tab and the second information is determined without reference to non-metadata content in the second tab.

In some aspects, the techniques described herein relate to a method, wherein the first information includes database information and contextual information, the database information determined using a database and the contextual information determined using a language model provided with the database information as input.

In some aspects, the techniques described herein relate to a method, wherein generating the information used to provide the user interface further includes: using a language model to generate a title for the user interface using the first entity and the second entity as inputs.

In some aspects, the techniques described herein relate to a system, wherein the memory is further configured with instructions to: provide a selectable control responsive to determining that the first tab is related to the first entity of the entity type and to the second tab related to the second entity of the entity type; and generate the information used to provide the user interface in response to receiving a selection of the selectable control.

In some aspects, the techniques described herein relate to a system, wherein generating the information used to provide the user interface further includes executing a language model using the first entity and the second entity as inputs to generate the first information and the second information.

In some aspects, the techniques described herein relate to a system, wherein the first information includes database information and contextual information, the database information determined using a database and the contextual information determined using a language model.

In some aspects, the techniques described herein relate to a non-transitory computer-readable medium further configured with executable instructions to: provide a selectable control responsive to determining that the first tab is related to the first entity of the entity type and to the second tab related to the second entity of the entity type; and generate the information used to provide the user interface in response to receiving a selection of the selectable control.

In some aspects, the techniques described herein relate to a non-transitory computer-readable medium, wherein generating the information used to provide the user interface further includes executing a language model using the first entity and the second entity as inputs to generate the first information and the second information.

In some aspects, the techniques described herein relate to a non-transitory computer-readable medium, wherein the first information includes database information and contextual information, the database information determined using a database and the contextual information determined using a language model.

In some aspects, the techniques described herein relate to a method including: determining that first content in a first tab of a browser is associated with a first entity of an entity type associated with a visited resource in a browser history; and in response to determining that the first content is associated with the entity type, generating information used to provide a user interface for displaying first information for the first entity and second information for a second entity.

In some aspects, the techniques described herein relate to a method, further including: in response to determining that the first content is associated with the entity type, providing a selectable control; and in response to receiving a selection of the selectable control, generating the information used to provide the user interface.

In some aspects, the techniques described herein relate to a method, wherein generating the information used to provide the user interface further includes executing a language model using the first entity and the second entity as inputs to generate the first information and the second information.

In some aspects, the techniques described herein relate to a method, wherein generating the information used to provide the user interface further includes using a language model to generate the first information and the second information given the first entity and the second entity as inputs.

In some aspects, the techniques described herein relate to a method, wherein the first information includes database information and contextual information, the database information determined using a database and the contextual information determined using a language model.

In some aspects, the techniques described herein relate to a method, wherein generating the information used to provide the user interface further includes determining an information category for the entity type using a database, the information category associated with the first information and the second information.

In some aspects, the techniques described herein relate to a method, wherein the first information is determined based on first metadata associated with the first tab.

In some aspects, the techniques described herein relate to a method, wherein the first information is determined without reference to non-metadata content in the first tab.

In some aspects, the techniques described herein relate to a method, wherein the first information is determined without reference to non-metadata content in the first tab. Various implementations of the systems and techniques described herein can be realized in digital electronic circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor and can be implemented in a high-level procedural and/or object-oriented programming language, and/or in assembly/machine language. As used herein, the terms “machine-readable medium” “computer-readable medium” refers to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

To provide for interaction with a user, the systems and techniques described herein can be implemented on a computer having a display device (e.g., a CRT (cathode ray tube) or LCD (liquid crystal display) monitor) for displaying information to the user and a keyboard and a pointing device (e.g., a mouse or a trackball) by which the user can provide input to the computer. Other kinds of devices can be used to provide for interaction with a user as well; for example, feedback provided to the user can be any form of sensory feedback (e.g., visual feedback, auditory feedback, or tactile feedback); and input from the user can be received in any form, including acoustic, speech, or tactile input.

The systems and techniques described herein can be implemented in a computing system that includes a back end component (e.g., as a data server), or that includes a middleware component (e.g., an application server), or that includes a front end component (e.g., a client computer having a graphical user interface or a Web browser through which a user can interact with an implementation of the systems and techniques described herein), or any combination of such back end, middleware, or front end components. The components of the system can be interconnected by any form or medium of digital data communication (e.g., a communication network). Examples of communication networks include a local area network (“LAN”), a wide area network (“WAN”), and the Internet.

The computing system can include clients and servers. A client and server are generally remote from each other and typically interact through a communication network. The relationship of client and server arises by virtue of computer programs running on the respective computers and having a client-server relationship with each other.

In some aspects, there is provided herein a computer-implemented method for performing the steps described herein.

In some aspects, there is provided herein a non-transitory computer-readable storage medium having instructions stored thereon that, in response to execution by one or more processors of a computing system, cause the computing system to perform the method described herein.

In some aspects, there is herein provided computer program instructions that when executed by one or more computers cause the one or more computers, cause the one or more computers to perform the method described herein.

A number of implementations have been described. Nevertheless, it will be understood that various modifications may be made without departing from the spirit and scope of the invention.

In addition, the logic flows depicted in the figures do not require the particular order shown, or sequential order, to achieve desirable results. In addition, other steps may be provided, or steps may be eliminated, from the described flows, and other components may be added to, or removed from, the described systems.

Further to the descriptions above, a user may be provided with controls allowing the user to make an election as to both if and when systems, programs, or features described herein may enable collection of user information (e.g., information from a browser history), and if the user is sent content or communications from a server. In addition, certain data may be treated in one or more ways before it is stored or used, so that personally identifiable information is removed. For example, a user's identity may be treated so that no personally identifiable information can be determined for the user, or a user's geographic location may be generalized where location information is obtained (such as to a city, ZIP code, or state level), so that a particular location of a user cannot be determined. Thus, the user may have control over what information is collected about the user, how that information is used, and what information is provided to the user.

1. A method comprising:
determining that first content in a first tab of a browser is associated with a first entity of an entity type and determining that second content in a second tab of the browser is associated with a second entity of the entity type; and
responsive to determining that the first tab is associated with the first entity of the entity type and that the second tab is associated with the second entity of the entity type, generating information used to provide a user interface for displaying first information for the first entity and second information for the second entity.

2. The method of claim 1, further comprising:
providing a selectable control responsive to determining that the first tab is related to the first entity of the entity type and to the second tab related to the second entity of the entity type;
receiving selection of the selectable control; and
generating the information used to provide the user interface in response to receiving the selection of the selectable control.

3. The method of claim 1, wherein generating the information used to provide the user interface further includes providing a language model with the first entity and the second entity as inputs, the language model generating an information category relating to the first information and the second information.

4. The method of claim 1, wherein generating the information used to provide the user interface further includes determining an information category for the entity type using a database, the information category associated with the first information and the second information.

5. The method of claim 1, wherein generating the information used to provide the user interface further includes using a language model to generate the first information and the second information given the first entity and the second entity as inputs.

6. The method of claim 1, wherein the first information is determined based on first metadata associated with the first tab and the second information is determined based on second metadata associated with the second tab.

7. The method of claim 1, wherein the first information is determined without reference to non-metadata content in the first tab and the second information is determined without reference to non-metadata content in the second tab.

8. The method of claim 1, wherein the first information includes database information and contextual information, the database information determined using a database and the contextual information determined using a language model provided with the database information as input.

9. The method of claim 1, wherein generating the information used to provide the user interface further includes:
using a language model to generate a title for the user interface using the first entity and the second entity as inputs.

10. A system comprising:
a processor; and
a memory configured with instructions to:
determine that first content in a first tab of a browser is associated with a first entity of an entity type and determining that second content in a second tab of the browser is associated with a second entity of the entity type; and
generate information used to provide a user interface for displaying first information for the first entity and second information for the second entity responsive to determining that the first tab is associated with the first entity of the entity type and that the second tab is associated with the second entity of the entity type.

11. The system of claim 10, wherein the memory is further configured with instructions to:
provide a selectable control responsive to determining that the first tab is related to the first entity of the entity type and to the second tab related to the second entity of the entity type; and
generate the information used to provide the user interface in response to receiving a selection of the selectable control.

12. The system of claim 10, wherein generating the information used to provide the user interface further includes executing a language model using the first entity and the second entity as inputs to generate the first information and the second information.

13. The system of claim 10, wherein the first information includes database information and contextual information, the database information determined using a database and the contextual information determined using a language model.

14. A non-transitory computer-readable medium storing executable instructions that, when executed by a processor, cause a computing device to:
determine that first content in a first tab of a browser is associated with a first entity of an entity type and determining that second content in a second tab of the browser is associated with a second entity of the entity type; and
generate information used to provide a user interface for displaying first information for the first entity and second information for the second entity responsive to determining that the first tab is associated with the first entity of the entity type and that the second tab is associated with the second entity of the entity type.

15. The non-transitory computer-readable medium of claim 14 further configured with executable instructions to:
provide a selectable control responsive to determining that the first tab is related to the first entity of the entity type and to the second tab related to the second entity of the entity type; and
generate the information used to provide the user interface in response to receiving a selection of the selectable control.

16. The non-transitory computer-readable medium of claim 14, wherein generating the information used to provide the user interface further includes executing a language model using the first entity and the second entity as inputs to generate the first information and the second information.

17. The non-transitory computer-readable medium of claim 14, wherein the first information includes database information and contextual information, the database information determined using a database and the contextual information determined using a language model.

18. The non-transitory computer-readable medium of claim 14, wherein the first information is determined based on first metadata associated with the first tab and the second information is determined based on second metadata associated with the second tab.

19. The non-transitory computer-readable medium of claim 14, wherein the first information includes database information and contextual information, the database information determined using a database and the contextual information determined using a language model provided with the database information as input.

20. The non-transitory computer-readable medium of claim 14, the executable instructions further causing the computing device to:
determine that third content in a third tab of the browser is associated with a third entity of the entity type; and
provide a control configured to add the third entity to the user interface.
